(19) United States
(12) Patent Application Publication
(10) Pub. No.: US 2025/0166344 A1
(43) Pub. Date: May 22, 2025

(54) SYSTEMS AND METHODS FOR HYPERSPECTRAL IMAGE PROCESSING IN REMOTE SENSING USING REFLEXIVITY BASED APPROXIMATE COMPUTING

(71) Applicant: Tata Consultancy Services Limited, Mumbai (IN)

(72) Inventors: Shruti Kunal KUNDE, Thane West (IN); Rekha SINGHAL, Thane West (IN); Aaditi KAPRE, Thane West (IN); Sparsh MITTAL, Uttarakhand (IN)

(73) Assignee: Tata Consultancy Services Limited, Mumbai (IN)

(21) Appl. No.: 18/928,530

(22) Filed: Oct. 28, 2024

(30) Foreign Application Priority Data
Nov. 16, 2023 (IN) 202321078005

(51) Int. Cl. G06V 10/60; G06V 10/762

(52) U.S. Cl. CPC G06V 10/60; G06V 10/762

(57) ABSTRACT

In remote sensing, hyperspectral (HS) images are acquired to study earth's surface. Processing of HS images through neural networks demands significant computational resources for both training and inference phases. The present disclosure addresses the unresolved problem of the conventional methods for reducing dimensions in hyper-spectral data and accelerating the training and inference of a model by applying approximate computing techniques. The approximate computing techniques leverage physical properties of a reflectance spectra. This makes the HS images interpretable across various applications. In the present disclosure, three reflexivity-based approximate computing techniques namely R-Hop(K), R-Top(N), and R-Proximity(N) are implemented. These reflexivity-based approximate computing techniques use spectral clustering methods that rely on reflectance values to capture inherent characteristics from hyperspectral images across diverse domains. Further, existing spatial dimension reduction techniques and a combination of spatial and spectral dimension reduction techniques are evaluated.

### PRIORITY CLAIM

This U.S. patent application claims priority under 35 U.S.C. § 119 to: Indian Patent Application No. 202321078005, filed on 16 Nov. 2023. The entire contents of the aforementioned application are incorporated herein by reference.

### TECHNICAL FIELD

The disclosure herein generally relates to the field of remote sensing, and, more particularly, to systems and methods for hyperspectral image processing in remote sensing using reflexivity based approximate computing.

### BACKGROUND

Remote sensing (RS) is an interdisciplinary field that enables visualization and comprehension of geographic locations on Earth's surface. RS leverages cutting-edge technology, such as aircraft-mounted sensors and sonars on ships and satellites, to collect and interpret information about the Earth from a distance. In remote sensing technology, hyperspectral data is used to study the earth's surface. Data is typically collected through specialized imaging techniques that capture contiguous wavelength bands across the electromagnetic spectrum. Data is collected as a data cube, with the XY plane representing the spatial information and the Z dimension representing the spectral information. The extensive spectral information, acquired at narrow bands and high spatial resolution, results in substantial hyperspectral image sizes.

Hyperspectral (HS) image processing involves a series of steps to extract meaningful information, including data acquisition from sensors, feature extraction to identify relevant spectral signatures, and classification for categorizing each pixel into specific land cover classes or materials. High dimensions of HS data lead to large-sized images. Hence, the processing of HS images leads to high training and inference latency. In other words, processing of HS images through neural networks demands significant computational resources for both training and inference phases.

Dimensionality reduction, one of the popular approximate computing techniques is explored to reduce the size of HS images for improving system performance of a model. There exists some conventional methods such as Principal Component Analysis (PCA) and Minimum Noise Fraction (MNF) for reducing the dimensionality. However, these methods fall short of capturing non-linear relationships in complex spectral signatures. Furthermore, being statistical in nature, these methods exhibit limited generalization across different domains.

### SUMMARY

Embodiments of the present disclosure present technological improvements as solutions to one or more of the above-mentioned technical problems recognized by the inventors in conventional systems. For example, in one embodiment, a processor implemented method is provided. The processor implemented method, comprising receiving, via one or more hardware processors, a plurality of hyperspectral image patches of one or more regions of earth's surface using one or more remote sensing mediums; computing, via the one or more hardware processors, an average of a plurality of reflectance values of each of a plurality of spectral bands in each of the plurality of hyperspectral image patches; obtaining, via the one or more hardware processors, a plurality of clusters of spectral bands based on a computed average of the plurality of reflectance values across all pixels in each of the plurality of hyperspectral image patches using a clustering technique, wherein each cluster comprises a subset of spectral bands from the plurality of spectral bands; and performing, via the one or more hardware processors, at least one of a plurality of reflexivity-based approximate computing techniques on the plurality of hyperspectral image patches for reducing a number of the plurality of spectral bands in each of the plurality of hyperspectral image patches by, wherein the plurality of reflexivity-based approximate computing techniques comprise (i) a R-Hop(K) technique, a R-Top(N) technique and a R-Proximity(N) technique.

In another aspect, a system is provided. The system comprising a memory storing instructions; one or more communication interfaces; and one or more hardware processors coupled to the memory via the one or more communication interfaces, wherein the one or more hardware processors are configured by the instructions to: receive a plurality of hyperspectral image patches of one or more regions of earth's surface using one or more remote sensing mediums; compute an average of a plurality of reflectance values of each of a plurality of spectral bands in each of the plurality of hyperspectral image patches; obtain a plurality of clusters of spectral bands based on a computed average of the plurality of reflectance values across all pixels in each of the plurality of hyperspectral image patches using a clustering technique, wherein each cluster comprises a subset of spectral bands from the plurality of spectral bands; and perform at least one of a plurality of reflexivity-based approximate computing techniques on the plurality of hyperspectral image patches for reducing a number of the plurality of spectral bands in each of the plurality of hyperspectral image patches, wherein the plurality of reflexivity-based approximate computing techniques comprise (i) a R-Hop(K) technique, a R-Top(N) technique and a R-Proximity(N) technique.

In yet another aspect, a non-transitory computer readable medium is provided. The non-transitory computer readable medium are configured by instructions for receiving a plurality of hyperspectral image patches of one or more regions of earth's surface using one or more remote sensing mediums; computing an average of a plurality of reflectance values of each of a plurality of spectral bands in each of the plurality of hyperspectral image patches; obtaining a plurality of clusters of spectral bands based on a computed average of the plurality of reflectance values across all pixels in each of the plurality of hyperspectral image patches using a clustering technique, wherein each cluster comprises a subset of spectral bands from the plurality of spectral bands; and performing at least one of a plurality of reflexivity-based approximate computing techniques on the plurality of hyperspectral image patches for reducing a number of the plurality of spectral bands in each of the plurality of hyperspectral image patches by, wherein the plurality of reflexivity-based approximate computing techniques comprise (i) a R-Hop(K) technique, a R-Top(N) technique and a R-Proximity(N) technique.

In accordance with an embodiment of the present disclosure, the R-Hop(K) technique comprising: ranking each spectral band in the plurality of spectral bands in an order of the plurality of reflectance values; and performing a uniform sampling on the ranked plurality of spectral bands by selecting a plurality of alternate bands from the ranked plurality of spectral bands based on a prespecified hop size K, wherein the plurality of alternate bands represent a reduced number of the plurality of spectral bands.

In accordance with an embodiment of the present disclosure, the R-Top(N) technique comprising: ranking each spectral band in the subset of spectral bands comprised in each cluster in an order of the plurality of reflectance values; and performing a uniform sampling on the ranked subset of spectral bands in each cluster by selecting a plurality of N high ranked bands from the ranked subset of spectral bands, wherein the plurality of N high ranked bands represent a reduced number of the subset of spectral bands.

In accordance with an embodiment of the present disclosure, the R-Proximity(N) technique comprising: ranking each spectral band in the subset of spectral bands comprised in each cluster in an order of the plurality of reflectance values; and performing a uniform sampling on the ranked subset of spectral bands in each cluster by selecting a plurality of N closest bands from the ranked subset of spectral bands based on a distance from a centroid of each cluster, wherein the plurality of N closest bands represent a reduced number of the subset of spectral bands.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles:

FIG. 1 illustrates an exemplary system for hyperspectral image processing in remote sensing using reflexivity based approximate computing, according to some embodiments of the present disclosure.

FIG. 2 illustrates an exemplary flow diagram illustrating a method for hyperspectral image processing in remote sensing using reflexivity based approximate computing, using the system of FIG. 1, according to some embodiments of the present disclosure.

FIG. 3 shows an example of remote sensing for collecting hyperspectral data of the earth's surface, according to some embodiments of the present disclosure.

FIG. 4 depicts an example of a hyperspectral image acquired using remote sensing, according to some embodiments of the present disclosure.

FIG. 5 depicts an illustrative example for each of the plurality of reflexivity-based approximate computing techniques, according to some embodiments of the present disclosure.

FIGS. 6A through 6C illustrate a plurality of pixel-collapsing techniques for spatial data reduction, according to some embodiments of the present disclosure.

FIG. 7 shows sample images from each dataset for hyperspectral image processing in remote sensing using reflexivity based approximate computing, according to some embodiments of the present disclosure.

FIGS. 8A through 8I depict graphical representations illustrating comparison of performance of Spectral, Spatial, and Spatial-Spectral reduction approaches respectively on Trento, Houston, Muufl Datasets, according to some embodiments of the present disclosure.

### DETAILED DESCRIPTION

Exemplary embodiments are described with reference to the accompanying drawings. In the figures, the left-most digit(s) of a reference number identifies the figure in which the reference number first appears. Wherever convenient, the same reference numbers are used throughout the drawings to refer to the same or like parts. While examples and features of disclosed principles are described herein, modifications, adaptations, and other implementations are possible without departing from the scope of the disclosed embodiments. It is intended that the following detailed description be considered as exemplary only, with the true scope being indicated by the following embodiments described herein.

Remote sensing (RS) is a process of gathering information about objects, areas or phenomena from the earth's surface using various sensors and instruments, such as cameras or satellites, located at a distance above a target. Instruments are designed to detect various wavelengths of electromagnetic spectrum. Remote sensing provides valuable insights in detecting changes in land cover and pollution and assessing crop health. It has wide applications in urban planning, disaster management and environmental monitoring. Hyperspectral imaging is an RS technology that uses hyper-spectral cameras, having a high spatial resolution, that can sample a broad spectral range of wavelengths. The proliferation of RS data in recent years has given rise to a multitude of challenges. Hyper-spectral data is very large in size and requires a significant amount of storage and computing capabilities for processing. For example, a typical hyperspectral image having spatial dimensions of 1024×1024 pixels and 224 spectral bands has a size in the range of 200 MB to 1 GB. This leads to large training and inference latency, adversely affecting outcome of downstream machine learning and deep learning models. The numerous spectral bands increase dimensions of the data, making it challenging to process and analyze. Feature extraction becomes a complex and time-consuming task. Target locations on the earth's surface exhibit spectral variability due to lighting conditions and sensor characteristics, and hence, identifying relevant spectral bands for processing becomes complex.

During natural disasters, hyper-spectral data is extremely beneficial in assessing the extent of damage and rescue operations, especially from remote locations. Large data sizes incur extremely large training and inference times for models trained on hyper-spectral data, which has an adverse impact on real-time operations. It is crucial to avoid data overload since large data storage, transmission, and management is time-consuming and resource-intensive. Performing operations on high dimensional data requires large amounts of memory and compute resources, necessitating specialized techniques such as band reduction. Multiple use cases, such as precision agriculture, oil-spill detection, health monitoring, disease detection, military and defense search and rescue operations, exhibit a need for timely, accurate and resource-efficient hyperspectral data processing.

Hyperspectral data of the earth's surface is collected by sensors mounted aboard aircraft flying at different altitudes, satellites, drones or ground-based instruments. As the sensor moves, it emits light towards the earth's surface. Objects on the Earth's surface reflect or emit radiations at varying wavelengths. Hyperspectral sensors capture these radiations in the form of multiple wavelengths. Intensity of the radiation emitted from the earth's surface is recorded in form of spectral bands. This provides a spectrum of measurements for each pixel in the image termed as reflectance values. The reflectance values measure the intensity of radiation for a particular pixel and wavelength. They show the degree to which every object reflects different wavelengths and thus, are characteristic of every object. Principal Component Analysis (PCA) is a popular technique for band reduction. It reduces data dimensions by capturing maximum variance and reducing noise. While it is a robust and versatile technique for reducing dimensions, it is computationally expensive when used for hyperspectral data. Spectral indexing is another technique used to summarize spectral information into a single value or a small set of values. However, this technique is domain-knowledge specific and cannot be generalized.

The present disclosure addresses the unresolved problem of the conventional methods for reducing dimensions in hyper-spectral data and accelerating the training and inference of a model by applying approximate computing techniques. Embodiments of the present disclosure provide approximate computing techniques that leverage physical properties of a reflectance spectra. This makes the HS images interpretable across various applications. In the present disclosure, three spectral dimensionality reduction techniques are provided. These techniques use spectral clustering methods that rely on reflectance values to capture inherent characteristics from hyperspectral images across diverse domains. Further, existing spatial dimension reduction techniques and a combination of spatial and spectral dimension reduction techniques are evaluated in the present disclosure.

Extensive experiments are conducted on three real-world open-source datasets, encompassing urban and rural landscapes. It is shown through experiments that the method of the present disclosure reduces training time by up to 8 times and inference time by up to 5 times, while reducing model size by up to 3 times. The method of the present disclosure has a negligible impact on accuracy. By contrast, conventional methods such as PCA and MNF techniques incur 3 times higher pre-processing latency overheads than the method of the present disclosure and also degrade the accuracy. The method of the present disclosure optimize training and inference latency while maintaining accuracy values and thus, are promising for addressing computational challenges of hyperspectral image processing. More specifically, the present disclosure describes the following:
1. Domain-agnostic Reflexivity-based approximate computing (RA×C) techniques to reduce dimensions of hyperspectral data and consequently enhance system performance of a model by optimizing the training and inference latency.
2. Combining spatial and spectral data reduction techniques for efficiently processing hyperspectral data.
3. Benchmarking performance of RA×C techniques with well-known dimensionality reduction techniques like PCA and MNF.
4. Validating the efficacy of RA×C techniques on three real-world open-source data sets, namely Houston, Trento and Muufl, capturing both rural and urban terrain.

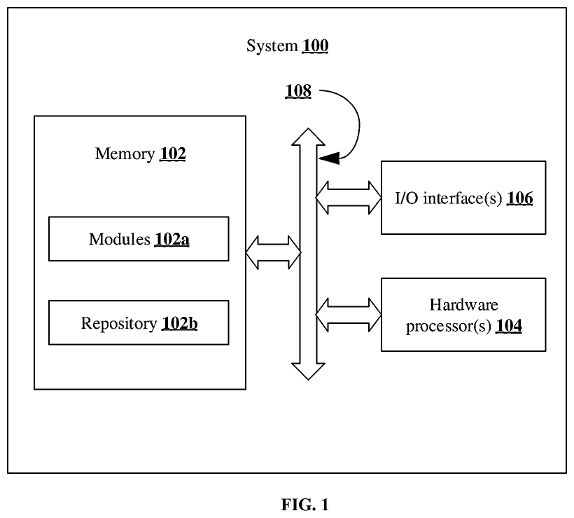

Referring now to the drawings, and more particularly to FIGS. 1 through 8I, where similar reference characters denote corresponding features consistently throughout the figures, there are shown preferred embodiments and these embodiments are described in the context of the following exemplary system and/or method.

FIG. 1 illustrates an exemplary system for hyperspectral image processing in remote sensing using reflexivity based approximate computing according to some embodiments of the present disclosure. In an embodiment, the system 100 includes or is otherwise in communication with one or more hardware processors 104, communication interface device(s) or input/output (I/O) interface(s) 106, and one or more data storage devices or memory 102 operatively coupled to the one or more hardware processors 104. The one or more hardware processors 104, the memory 102, and the I/O interface(s) 106 may be coupled to a system bus 108 or a similar mechanism.

The I/O interface(s) 106 may include a variety of software and hardware interfaces, for example, a web interface, a graphical user interface, and the like. The I/O interface(s) 106 may include a variety of software and hardware interfaces, for example, interfaces for peripheral device(s), such as a keyboard, a mouse, an external memory, a plurality of sensor devices, a printer and the like. Further, the I/O interface(s) 106 may enable the system 100 to communicate with other devices, such as web servers and external databases.

The I/O interface(s) 106 can facilitate multiple communications within a wide variety of networks and protocol types, including wired networks, for example, local area network (LAN), cable, etc., and wireless networks, such as Wireless LAN (WLAN), cellular, or satellite. For the purpose, the I/O interface(s) 106 may include one or more ports for connecting a number of computing systems with one another or to another server computer. Further, the I/O interface(s) 106 may include one or more ports for connecting a number of devices to one another or to another server.

The one or more hardware processors 104 may be implemented as one or more microprocessors, microcomputers, microcontrollers, digital signal processors, central processing units, state machines, logic circuitries, and/or any devices that manipulate signals based on operational instructions. Among other capabilities, the one or more hardware processors 104 are configured to fetch and execute computer-readable instructions stored in the memory 102. In the context of the present disclosure, the expressions processors and hardware processors may be used interchangeably. In an embodiment, the system 100 can be implemented in a variety of computing systems, such as laptop computers, portable computer, notebooks, hand-held devices, workstations, mainframe computers, servers, a network cloud and the like.

The memory 102 may include any computer-readable medium known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes. In an embodiment, the memory 102 includes a plurality of modules 102a and a repository 102b for storing data processed, received, and generated by one or more of the plurality of modules 102a. The plurality of modules 102a may include routines, programs, objects, components, data structures, and so on, which perform particular tasks or implement particular abstract data types.

The plurality of modules 102a may include programs or computer-readable instructions or coded instructions that supplement applications or functions performed by the system 100. The plurality of modules 102a may also be used as, signal processor(s), state machine(s), logic circuitries, and/or any other device or component that manipulates signals based on operational instructions. Further, the plurality of modules 102a can be used by hardware, by computer-readable instructions executed by the one or more hardware processors 104, or by a combination thereof. Further, the memory 102 may include information pertaining to input(s)/output(s) of each step performed by the processor(s) 104 of the system 100 and methods of the present disclosure.

The repository 102b may include a database or a data engine. Further, the repository 102b amongst other things, may serve as a database or includes a plurality of databases for storing the data that is processed, received, or generated as a result of the execution of the plurality of modules 102a. Although the repository 102b is shown internal to the system 100, it will be noted that, in alternate embodiments, the repository 102b can also be implemented external to the system 100, where the repository 102b may be stored within an external database (not shown in FIG. 1) communicatively coupled to the system 100. The data contained within such external database may be periodically updated. For example, new data may be added into the external database and/or existing data may be modified and/or non-useful data may be deleted from the external database. In one example, the data may be stored in an external system, such as a Lightweight Directory Access Protocol (LDAP) directory and a Relational Database Management System (RDBMS). In another embodiment, the data stored in the repository 102b may be distributed between the system 100 and the external database.

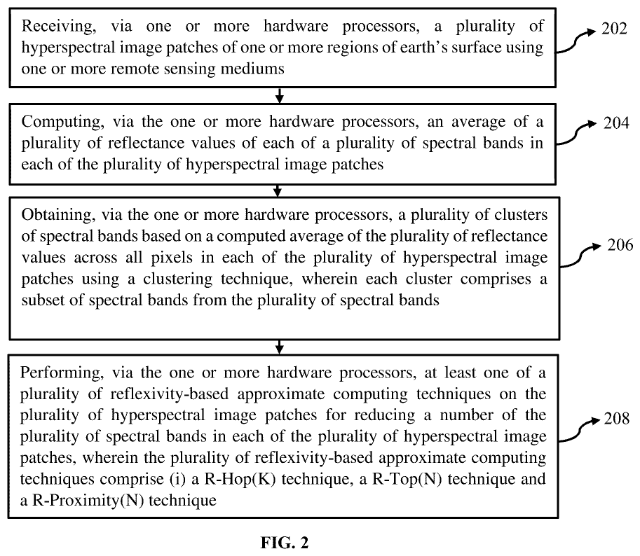

Embodiments of the present disclosure provide systems and methods for hyperspectral image processing in remote sensing using reflexivity based approximate computing. In context of the present disclosure, the expressions ‘hyperspectral images’, and ‘images’ may be interchangeably used throughout the description. FIG. 2, with reference to FIG. 1, illustrates an exemplary flow diagram illustrating a method for hyperspectral image processing in remote sensing using reflexivity based approximate computing, using the system of FIG. 1, in accordance with some embodiments of the present disclosure.

Referring to FIG. 2, in an embodiment, the system(s) 100 comprises one or more data storage devices or the memory 102 operatively coupled to the one or more hardware processors 104 and is configured to store instructions for execution of steps of the method by the one or more processors 104. The steps of the method 200 of the present disclosure will now be explained with reference to components of the system 100 of FIG. 1, the flow diagram as depicted in FIG. 2, and one or more examples. Although steps of the method 200 including process steps, method steps, techniques or the like may be described in a sequential order, such processes, methods and techniques may be configured to work in alternate orders. In other words, any sequence or order of steps that may be described does not necessarily indicate a requirement that the steps be performed in that order. The steps of processes described herein may be performed in any practical order. Further, some steps may be performed simultaneously, or some steps may be performed alone or independently.

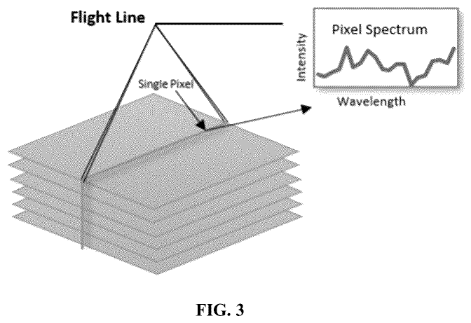

In an embodiment, at step 202 of the present disclosure, the one or more hardware processors 104 are configured to receive a plurality of hyperspectral image patches of one or more regions of earth's surface using one or more remote sensing mediums. In an embodiment, the one or more remote sensing mediums may comprise but ae not limited to sensors mounted aboard aircraft flying at different altitudes, satellites, drones or ground-based instruments. FIG. 3 shows an example of remote sensing for collecting hyperspectral data of the earth's surface, according to some embodiments of the present disclosure. As shown in FIG. 3, the hyperspectral data of the earth's surface is collected by the sensors mounted aboard aircraft flying at different altitudes, satellites, drones or ground-based instruments. As the sensor moves, it emits light towards the earth's surface. Objects on the Earth's surface reflect or emit radiations at varying wavelengths. Hyperspectral sensors capture these radiations in the form of multiple wavelengths. The intensity of the radiation emitted from the earth's surface is recorded in the form of spectral bands. This provides a spectrum of measurements for each pixel in the image termed as reflectance values. The reflectance values measure the intensity of radiation for a particular pixel and wavelength. They show the degree to which every object reflects different wavelengths and thus, are characteristic of every object.

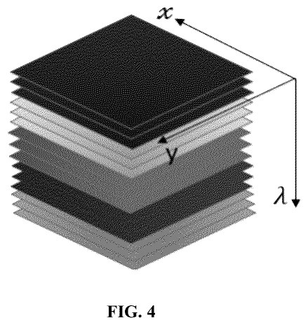

In an embodiment, unlike conventional Red, Green, and Blue (RGB) images, a hyperspectral image comprises multiple spectral bands, each representing a specific wavelength. FIG. 4 depicts an example of a hyperspectral image acquired using remote sensing, according to some embodiments of the present disclosure. As shown in FIG. 4, the typical hyperspectral image combines spatial and spectral information to provide a detailed representation of the image. The pixels in a hyper-spectral image are arranged as a grid depicted by x and y as shown in FIG. 4. This is the spatial component of the image, which refers to the image's resolution in terms of the image's physical dimensions on the Earth's surface. In open-source datasets used in the present disclosure, entire hyperspectral image is broken down into smaller spatial hyperspectral image patches since the entire image is too big (1 to 3 GBs) to be processed with even high-end GPUs. These hyperspectral image patches have 11×11 pixels in the spatial dimension, and each pixel contains all the spectral bands. Hence, every patch is a hyperspectral cube. For example, a patch with a dimension of 144*11*11 has 144 spectral bands. The spectral component A refers to electromagnetic waves captured at different wavelengths for each pixel in the hyperspectral image. This data is captured across contiguous spectral bands. The size of the hyperspectral image can vary depending on sensor's spatial and spectral resolution and covered area. Hyperspectral sensors capture data across near-infrared (NIR), which is visible (around 400 nm) to shortwave infrared (2500 nm). Thus, the hyperspectral images are quite large due to numerous spectral bands and high spatial resolution. Hence, training deep learning models on high-dimensional hyper-spectral data is time-consuming. Inference times are also substantial due to computational requirements of numerous spectral bands. Pre-processing techniques for data reduction play a significant role in rendering hyper-spectral data manageable for analysis.

Further, at step 204 of the present disclosure, the one or more hardware processors 104 are configured to compute an average of a plurality of reflectance values of each of a plurality of spectral bands in each of the plurality of hyperspectral image patches. In an embodiment, spectral reflectance of a surface refers to ratio of reflected energy to incident energy and is measured as a function of wavelength. While forest and dark soil have a low reflectance (e.g., between 5 to 10%), thick clouds and fresh snow have a high reflectance (e.g., 75 to 80%). Thus, based on the spectral reflectance properties, nature of a surface is identified. In the HS image, the spectral bands are arranged based on increasing wavelength value. The plurality of reflectance values are the intensity with which the wavelength can be reflected, which does not follow any order across the spectral bands. In other words, the average of the plurality of reflectance values across all pixels in the image is computed, providing a single value representing each spectral band. This gives a generalized technique that can be replicated across all spectral bands, thus eliminating a need to have any domain knowledge to choose spectral bands. Additionally, averaging reduces the computations drastically compared to complex statistical measures. The averaging also gives equal weightage to all classes. Hence, selected spectral bands are a representative subset of all classes. This results in good classification accuracy for all pixels, even with fewer spectral bands.

Further, at step 206 of the present disclosure, the one or more hardware processors 104 are configured to obtain a plurality of clusters of spectral bands based on a computed average of the plurality of reflectance values across all pixels in each of the plurality of hyperspectral image patches using a clustering technique. Each cluster comprises a subset of spectral bands from the plurality of spectral bands. In an embodiment, the clustering technique could be but not limited to K-means clustering technique. In the context of the present disclosure, there are three clusters of the spectral bands. In other words, the spectral bands are clustered based on their average reflectance values. Selecting spectral bands from all clusters ensures that selection covers all objects in the image which means the objects that do not reflect with a high intensity and the objects that do are covered.

At step 208 of the present disclosure, the one or more hardware processors 104 are configured to perform at least one of a plurality of reflexivity-based approximate computing (RA×C) techniques on the plurality of hyperspectral image patches for reducing a number of the plurality of spectral bands in each of the plurality of hyperspectral image patches. In other words, the plurality of reflexivity-based approximate computing (RA×C) techniques are used for reducing spectral dimensions. The reflectance values are directly related to the physical properties of objects on the Earth's surface. Hence, reflectance values can be used to correlate between the reduced dimensions and actual physical entity on Earth. Reflectance signatures also facilitate discrimination of different objects, leading to more accurate classification. Reflectance values are normalized and standardized, enabling meaningful comparisons among different spectral bands in a dataset. Leveraging these reflectance values, Reflexivity is provided which is referred as an algorithm that represents a spectral band as a function of its reflectance values across as entire image. The algorithm uses the reflectance values to provide a method to rank and sample the spectral bands to reduce data dimension based on reflectance values. The algorithm aims to introduce a meaningful, domain-agnostic, statistical metric to select bands, thus reducing the number of bands in original data. This directly reduces computation overhead. The original reflectance values for each pixel are restored for the selected, reduced number of bands before passing the data to a deep learning model. This defines reflexivity as a dimensionality reduction-based approximate computing technique because each spectral band is represented as an approximation of its reflectance value over an entire image by averaging. Compared to traditional techniques like PCA that involve time-consuming eigenvalue calculations for band selection, the plurality of reflexivity-based approximate computing (RA×C) techniques significantly reduce computations for spectral band selection. Use of averaging in reflexivity provides robustness to as it captures minor changes in the reflectance values. Approximate computing based on reflexivity reduces the training and inference latency of deep learning models by virtue of enabling faster processing.

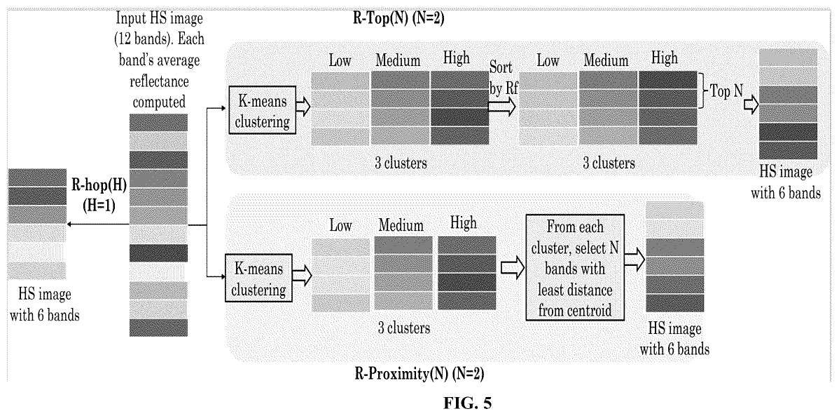

The plurality of reflexivity-based approximate computing techniques comprise (i) a R-Hop(K) technique, a R-Top(N) technique and a R-Proximity(N) technique. FIG. 5 depicts an illustrative example for each of the plurality of reflexivity-based approximate computing techniques, according to some embodiments of the present disclosure. The R-Hop(K) technique comprises ranking each spectral band in the plurality of spectral bands in an order of the plurality of reflectance values; and performing a uniform sampling on the ranked plurality of spectral bands by selecting a plurality of alternate bands from the ranked plurality of spectral bands based on a prespecified hop size K. The plurality of alternate bands represent a reduced number of the plurality of spectral bands. In other words, in the R-Hop(K) technique, initially, image reflectance values across the spatial dimensions are averaged for every band. Further, the spectral bands are sorted in order of reflectance values. Next, uniform sampling is performed from the available spectral bands to obtain a reduced and representative spectral signature. Alternate spectral bands are selected based on a particular hop size K, which can be 1, 2 or 3. For example, every other band is selected for a hop size of 1. This technique uses a good uniform representation of spectral bands from each cluster. It is ensured that the reflectance values too close to each other are not selected. This gives a representative subset of all the averaged reflectance values and thereby, all the bands. Hence, it helps in obtaining a good coverage of all the physical objects in the image.

The R-Top(N) technique comprises ranking each spectral band in the subset of spectral bands comprised in each cluster in an order of the plurality of reflectance values; and performing a uniform sampling on the ranked subset of spectral bands in each cluster by selecting a plurality of N high ranked bands from the ranked subset of spectral bands. The plurality of N high ranked bands represent a reduced number of the subset of spectral bands. In other words, in the R-Top(N) technique, initially, procedure of averaging all the reflectance values across the spatial dimensions of the image for each spectral band is repeated. Next, the spectral bands are clustered into 3 clusters based on their spectral signatures and sorted according to average reflectance values. Further, top N candidates are sampled from each cluster. Here, the top are defined as highest reflectance values in each cluster. From each cluster, sampling is performed uniformly. Hence, N=Number of Desired bands/3. Distinctive spectral bands from each cluster are selected. This effectively reduces redundancy since spectral bands that may have same reflectance patterns are eliminated. In this technique, it is studied how numerically maximum values of reflectance from each band perform and whether preference for high reflectance values across spectrum leads to better results. However, since selection is done from all 3 clusters, it is also ensured that all objects from the image are encompassed for classification. It also mitigates noise and variability in original dataset.

The R-Proximity(N) technique comprises ranking each spectral band in the subset of spectral bands comprised in each cluster in an order of the plurality of reflectance values; and performing a uniform sampling on the ranked subset of spectral bands in each cluster by selecting a plurality of N closest bands from the ranked subset of spectral bands based on a distance from a centroid of each cluster. The plurality of N closest bands represent a reduced number of the subset of spectral bands. In other words, in the R-Proximity(N) technique, after averaging reflectance values for each spectral band, the spectral bands are divided into 3 clusters. Further, the spectral bands are sorted based on their distance (i.e., proximity) to the centroid instead of the reflectance value. The spectral bands with the least distance values which means closest to cluster centers are selected. By selecting spectral bands that are closest to the centroid, spectral bands that are most representative of the cluster's characteristics are selected. This technique essentially summarizes characteristics of each cluster by centroid value, ensuring that highest or lowest reflectance values are never selected. This prevents the data from being skewed towards extreme values. Hence, when the spectral bands from all 3 clusters are selected, a good coverage of the entire image is ensured.

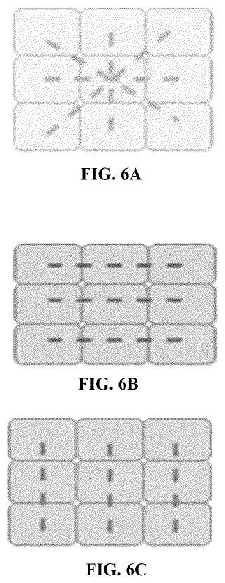

In an embodiment, while primary focus of the present disclosure is to reduce the spectral bands in HS images, known approaches for spatial reduction are also explored to achieve further reduction in image size. This would improve the system performance of a model for remote sensing datasets. Based on spatial locality of images, an approximate computing technique for spatial data reduction namely pixel-collapsing is selected. While this technique has been evaluated before in other contexts, it is not used for remote-sensing images. First, an original image is divided into non-overlapping 3×3 stencils. Then, the pixel-collapsing technique is used. FIGS. 6A through 6C illustrate a plurality of pixel-collapsing techniques for spatial data reduction, according to some embodiments of the present disclosure. As shown in FIGS. 6A through 6C, three pixel-collapsing techniques are used. As can be seen from FIG. 6A, for each 3×3 stencil, only center pixel is sampled. Thus, the center pixel approximates the neighboring eight pixels. This reduces the spatial dimension of the image by 88.9%. (2 and 3). In FIGS. 6B and 6C, only center row and center column respectively are sampled. These techniques reduce the spatial dimension of the image by 66.7%. These pixel-collapsing techniques reduce image resolution. This saves storage and reduces computation requirements at a cost of a minor loss in accuracy. In addition to spatial and spectral approximation, a combination of the spatial and spectral compression techniques is used and their impact on the system performance of a model is analyzed. The model could be a deep learning model, machine learning model, and/or the like.

In an embodiment, the entire method of the present disclosure can be further better understood by way of following pseudo code provided as example:

Require: HS image patches Pᵢ, method, desired number of bands b

| | |
|---|---|
| • | Method = R-Hop(K), R-Top(N), R-Proximity(N) |
| • | N=Number of bands selected from each cluster |
| • | K=Hop value, number of bands skipped after each |
| | selected band |
| • | Mₕₛ = Model used for training HS image patches |

Ensure: HS image patches with desired bands P_{ib}, Mₕₛ

| | |
|---|---|
| 1. | for each remote sensed patch P_{ib} ⊆ Iᵢ (RS image) do |
| 2. | A(Pᵢ) = Average of reflectance of each band. |
| 3. | end for |
| 4. | C(Pᵢ) = KMeans (Clusters = 3) |
| 5. | if method = R-Hop(K) then |
| 6. | Sᵣ(C(Pᵢ)) = Sort by reflectance value |
| 7. | P_{ib} = Select bands based on hop value K |
| 8. | end if |
| 9. | if method = R-Hop(N) then |
| 10. | Groupby in clusters C(Pᵢ) |
| 11. | Sᵣ(C(Pᵢ)) = Sort by reflectance value |
| 12. | Select top N bands from each group |
| 13. | P_{ib} = Sᵣ(C(Pᵢ)) |
| 14. | end if |
| 15. | if method = R-Proximity(N) then |
| 16. | Groupby in clusters C(Pᵢ) |
| 17. | S_{d}(C(Pᵢ)) = Sort by distance from centroid |
| 18. | Select top N bands from each group |
| 19. | P_{ib} = S_{d}(C(Pᵢ)) |
| 20. | end if |
| 21. | Train Mₕₛ with reduced spectral bands P_{ib}. |
| 22. | Test Mₕₛ with test dataset. |

### Datasets

In the present disclosure, the efficacy of the plurality of reflexivity-based approximate computing techniques (RA×C) techniques is validated on three real-world datasets. Each dataset has images gathered from multiple modalities, including hyper spectral (HS) and Light Detection and Ranging (LiDAR). In the present disclosure, focus is on the hyperspectral images only. The present disclosure aims to reduce the spectral and spatial dimensions of the HS images such that the training and inference latency is optimized without compromising the model accuracy. FIG. 7 shows sample images from each dataset for hyperspectral image processing in remote sensing using reflexivity based approximate computing, according to some embodiments of the present disclosure. The dataset used are described as follows:

A. Trento: The Trento dataset comprises of images from rural landscapes in Southern Italy. The data is multi-modal in nature, which means it encompasses a mix of hyperspectral and LiDAR images. These images are divided into 6 classes, namely, woods, buildings, vineyards, ground, apples and roads. The data is collected using AISA Eagle sensors. The images exhibit a spatial resolution of 1 m per pixel and a spectral resolution of 9.2 nm. These images consist of 64 spectral bands spanning the wavelength range from 0.42 to 0.99 μm. Regarding image dimensions, original image size comprises of 600×166 pixels. Notably, for training and testing purposes, an 11×11 pixel patch is selected from this larger image. The total number of pixels in an image is 99600. 69,386 pixels are in background, and 30,214 pixels are labeled with their distribution as shown in Table 1. Table 1 provides a class-wise number of patches in training and testing for the Trento dataset.

TABLE 1

| Landcover | Train | Test |
|---|---|---|
| Buildings | 3271 | 763 |
| Woods | 2343 | 560 |
| Roads | 391 | 88 |
| Apples | 7282 | 1841 |
| Ground | 8341 | 2160 |
| Vineyard | 2543 | 631 |
| Total | 24171 | 6043 |

B. Houston: The Houston dataset was shared during 2013 Data Fusion content of IEEE GRSS Geoscience Society. The dataset is captured by a Compact Airborne Spectrographic Imager (CASI). The dataset is multi-modal, which means it contains images gathered by different types of sensors such as Hyperspectral imaging (HSI), LiDAR and multispectral. The hyperspectral image has 144 spectral bands. The dataset has a 2.5 m spatial resolution with wavelengths ranging from 0.38 to 1.05 p. The land-cover and land-use images are distributed across 15 classes. Each image consists of 340×1905 pixels, of which 15209 are labeled pixels and 632671 are background pixels. The dataset comprises 12023 images for training and 3006 images for testing. Table 2 below provides image distribution for training and testing for the Houston dataset.

TABLE 2

| Land Cover | Train | Test |
|---|---|---|
| Grass-stressed | 1001 | 250 |
| Tree | 998 | 256 |
| Water | 556 | 141 |
| Commercial | 1002 | 242 |
| Highway | 988 | 254 |
| Parking-lot 1 | 281 | 44 |
| Tennis-court | 1007 | 261 |
| Grass-healthy | 1009 | 235 |
| Grass-synthetic | 1003 | 249 |
| Soil | 945 | 282 |
| Residential | 973 | 262 |
| Road | 997 | 236 |
| Railway | 374 | 95 |
| Parking-lot 2 | 344 | 84 |
| Running-track | 545 | 112 |
| Total | 12023 | 3006 |

C. Muufl: The Muufl dataset comprises Gulfport scene data that was acquired from the University of Southern Mississippi campus in November 2010 using a Reflective Optics System Imaging Spectrometer (ROSIS) sensor. The data collection included ground cover types such as water, beach, grass, tree, road, dead vegetation and dirt. In addition, there are other geographical features such as flat fields, wooded areas and buildings. There are 325×220 pixels with 72 spectral bands in the HSI of this dataset. Four initial and four final bands were removed due to noise, giving a total of 64 bands. The data depicts 11 urban land-cover classes containing 53687 ground truth pixels. Table 2 below provides image distribution for training and testing for the Muufl dataset.

TABLE 3

| Land cover | Train | Test |
|---|---|---|
| Grass-Pure | 4056 | 214 |
| Dirt-And-Sand | 1735 | 91 |
| Water | 443 | 23 |
| Buildings | 5928 | 312 |
| Yellow-Curb | 174 | 9 |
| Trees | 22084 | 1162 |
| Grass-Ground Surface | 6538 | 344 |
| Road-Materials | 6353 | 334 |
| Buildings-Shadows | 2121 | 112 |
| Sidewalk | 1316 | 69 |
| Cloth Panels | 256 | 13 |
| Total | 42949 | 10737 |

### EXPERIMENTAL SETUP

In the present disclosure, multiple experiments are designed to validate the efficacy of the plurality of reflexivity-based approximate computing (RA×C) techniques on three different real-world datasets, namely Trento, Houston and Muufl. The present disclosure aims to optimize the training and inference latency while ensuring that the model's accuracy is not adversely affected. The metrics measured are training time, inference time and accuracy. Experiments are conducted on a Linux Community ENTerprise Operating System 7 (CentOS7) server with 256 GB RAM and 56 core CPUs. A multi-modal fusion transformer is used. Input patches are taken from hyperspectral images. Each patch has 11×11 pixels. The image is divided into these patches and input to the model as an entire hyperspectral image cannot be processed at once due to its large size. Sequential layers of three dimensional convolutional layer (Conv3D) and HetConv2D are removed. The plurality of reflexivity-based approximate computing (RA×C) techniques, which require less computations and storage due to a lack of trainable weights and complex matrix calculations, replace this model-based pre-processing step. In the present disclosure, one 2D convolution layer is used to reduce number of input channels to desired number of output channels. For example, in the Trento dataset, by reflexivity, 64 bands are grouped into three clusters; 11 bands are sampled from each cluster, leading to 33 bands. These are input into the convolution layer to reduce to the desired number of bands which is 32. This convolution layer is followed by batch normalization and RELU activation layers. The multi-modal fusion transformer is used because the method of the present disclosure is extended to other modalities of data. The present disclosure is limited to hyperspectral data only. A Pytorch framework is used for implementation. In the present disclosure, following three sets of experiments are conducted on each dataset:
Spectral only—In this set of experiments, spatial dimensions of the image are not reduced, but spectral dimensions are reduced using the plurality of reflexivity-based approximate computing (RA×C) techniques.
Spatial only—In this set of experiments, only the spatial dimension of the image was reduced by applying the plurality of reflexivity-based approximate computing (RA×C) techniques. For every 3×3 stencil of the image, the pixels were collapsed to a single pixel in the center, a single pixel in each row and a single pixel in each column.
Spatial and Spectral—In this set of experiments, a best-performing spatial method is selected (namely, row pattern) and spectral reduction is applied to this image. Here, an effect of simultaneously applying both techniques on the image is analyzed.

Techniques used for comparison: The spectral and combination of spatial and spectral techniques are compared with the principal component analysis (PCA) and Minimum Noise Fraction (MNF) techniques which are two widely used techniques for reducing dimensions. PCA aids in extracting information from high-dimensional datasets. MNF is an improvement over PCA, and it seeks to transform data by separating the data from the noise. However, both techniques have their own limitations. PCA components are expressed in a mathematical form that may not directly be mapped to the original spectral bands, thus hindering the interpretation of reduced dimensions. MNF is compute-intensive and requires multiple steps to converge. It focuses on reducing noise, which may not necessarily lead to a significant reduction in the data dimensions.

### EXPERIMENTAL RESULTS

The efficacy of the plurality of reflexivity-based approximate computing (RA×C) techniques of the present disclosure was verified on 3 datasets—namely, Houston, Trento and Muufl. Muufl is the largest dataset, followed by Trento and Houston. Muufl has maximum number of patches and, hence, takes maximum time to train. Results are compared against respective baselines for that dataset. The baseline represents execution on a vanilla dataset without use of any dimensionality reduction technique. The aim of the present disclosure was to attain a reduction in the training and inference latency of the model while ensuring that the accuracy is not adversely affected.

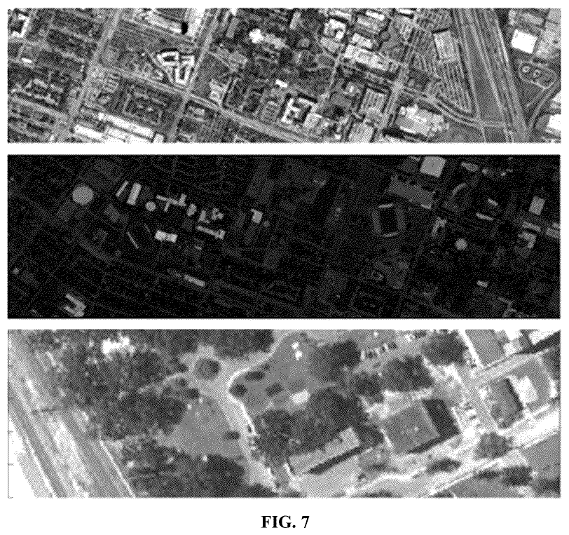

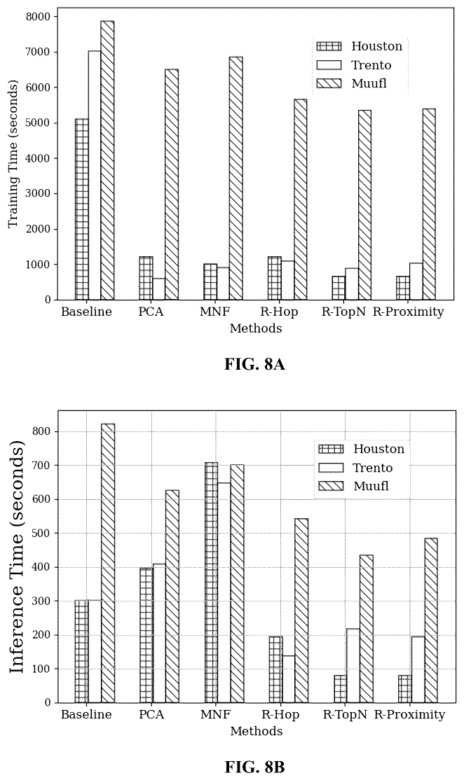

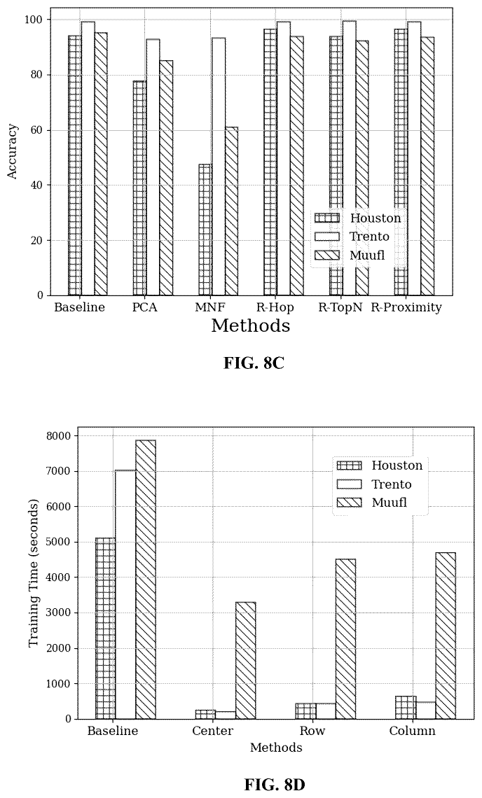

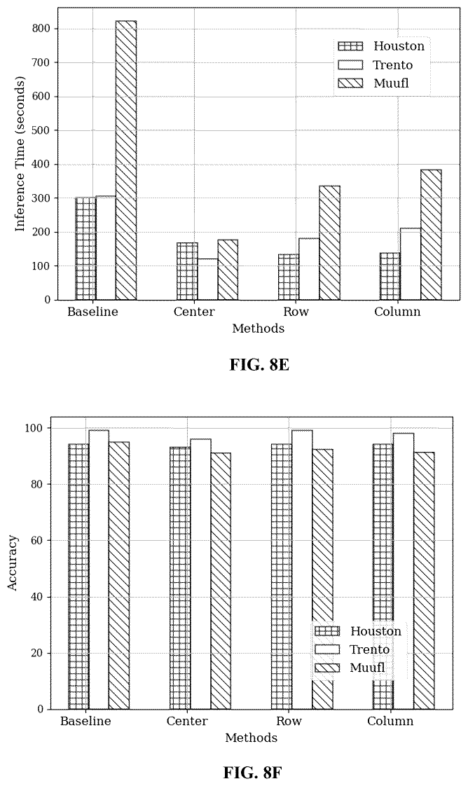

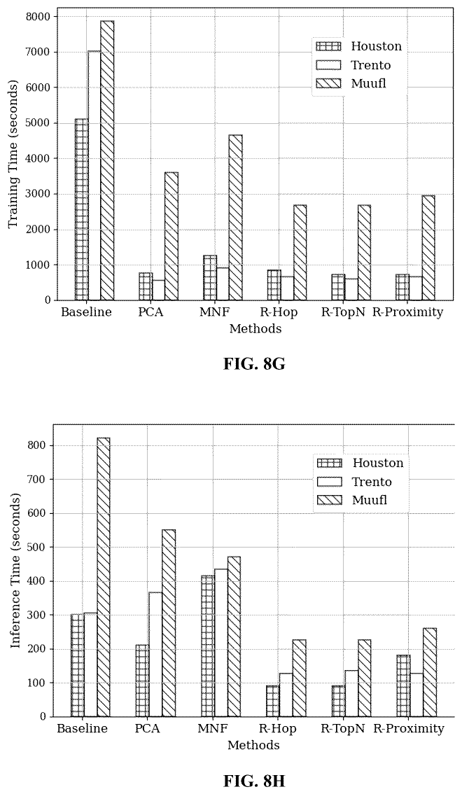

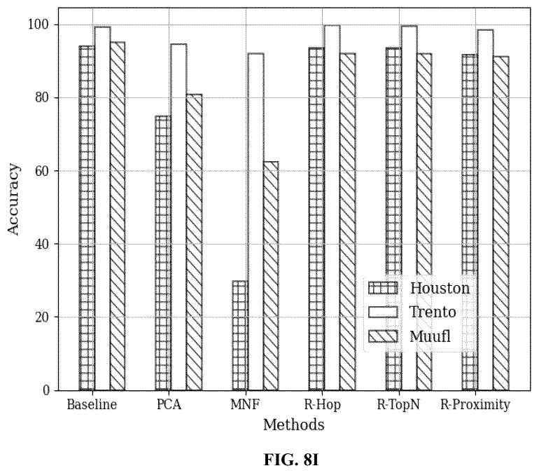

FIGS. 8A through 8I depict graphical representations illustrating comparison of performance of Spectral, Spatial, and Spatial-Spectral reduction approaches respectively on Trento, Houston, Muufl Datasets, according to some embodiments of the present disclosure.

A. Spectral reduction: FIGS. 8A through 8C depict graphical representations illustrating comparison of performance of spectral reduction approach on Trento, Houston, Muufl Datasets in terms of training time, inference time and accuracy respectively, according to some embodiments of the present disclosure. As shown in FIGS. 8A through 8C, the R-Hop(K) technique with K=1 which means skipping every alternate band was evaluated. For R-Top(N) and R-Proximity(N), N=11 was set. These two techniques pick 33 bands. The number of bands was reduced to 3 using a convolution layer. Thus, all three techniques reduced the number of bands by 50%. Specifically, in Trento and Muufl, the number of bands was reduced from 64 to 32, whereas in Houston, they were reduced from 144 to 72. As shown in FIGS. 8A and 8B, this significantly reduced the training time and inference time in all the datasets. The plurality of reflexivity-based approximate computing (RA×C) techniques also performed better than PCA and MNF. Also, while the plurality of reflexivity-based approximate computing (RA×C) techniques had negligible pre-processing times, PCA and MNF methods incurred more than 3 times higher pre-processing latency overheads. These latency overheads added to overall latency. Additionally, PCA and MNF techniques gave an accuracy of 92-93%, 47-77% and 60-83% in Trento, Houston, and Muufl, respectively, whereas bands selected by the plurality of reflexivity-based approximate computing (RA×C) techniques maintained an accuracy of 93-99% in all cases. It was observed that ranking of bands provided by eigenvalues was opposite to the ranking provided by their reflexivity scores. This shows that the plurality of reflexivity-based approximate computing (RA×C) techniques reduced dimensionality more than generalized statistical methods such as PCA or MNF.

B. Spatial reduction: Pixel collapsing technique for spatial reduction reduces pixels in each patch from 121 to 16 (center), 44 (row) and 44 (column). FIGS. 8D through 8F depict graphical representations illustrating comparison of performance of spatial reduction approach on Trento, Houston, Muufl Datasets in terms of training time, inference time and accuracy respectively, according to some embodiments of the present disclosure. It was observed in FIGS. 8D through 8F that the training latency reduced by a minimum of 56% for the Muufl dataset and up to 91% for the Houston dataset. Across all the datasets, the accuracy loss was less than 1%. Clearly, there was a significant redundancy in the image patches of 121 pixels; hence, collapsing those pixels into a few pixels does not significantly reduce the accuracy. As for the comparison between different pixel collapsing techniques, the highest accuracy drop was observed for the center pattern since it most aggressively reduced the number of pixels. The row-pattern scheme provided higher accuracy than the column-pattern scheme due to the presence of row symmetry in these images. These trends were consistent across all the three datasets. However, none of the three approaches showed a significant accuracy drop.

C. Spectral and Spatial reduction: In the present disclosure, experiments combining spatial (row-based) and spectral reduction techniques were also conducted. FIGS. 8G through 8I depict graphical representations illustrating comparison of performance of spatial reduction approach on Trento, Houston, Muufl Datasets in terms of training time, inference time and accuracy respectively, according to some embodiments of the present disclosure. A distinct pattern of reduction in training and inference latency was observed. All the reflexivity methods performed much better than PCA and MNF and maintained a high accuracy value. PCA and MNF showed a drastic drop in accuracy. Compared to the spectral reduction approach, combination of spatial and spectral techniques decreased memory size occupied by the model. For example, for the Muufl data set for R-Hop(1), the model size was 382 KB for the spectral approach and 363 KB for the combination of spatial and spectral approach. Reason for the model size was that there was a spatial reduction in addition to the spectral reduction. However, negligible differences between the accuracy and training/inference latency was observed and in general, both approaches performed well.

D. Size of the model: The spatial (row-pattern) and spectral dimension reduction techniques also reduced the model size. The baseline models with all bands and pixels occupied 2893 KB, 1059 KB, and 905 KB for Houston, Trento and Muufl datasets, respectively. This implies that higher the number of spectral bands, the more memory space the model requires. The spatial reduction technique gave less than 200 KB of reduction, but a 50% reduction in spectral bands reduces the model size by more than half. The combined spectral and spatial reduction techniques lead to a model size of 358 KB, 580 KB, 362 KB for Houston, Trento and Muufl datasets, respectively. Thus, the plurality of reflexivity-based approximate computing (RA×C) techniques reduced the model size between 66 to 83%, while reducing the accuracy by less than 3%.

E. Ablation Studies: In the present disclosure, ablation studies have been conducted to study the behavior of the plurality of reflexivity-based approximate computing (RA×C) techniques on the training and inference latency with varying bands. For all three datasets, the number of spectral bands were decreased using the plurality of reflexivity-based approximate computing (RA×C) techniques. Table 4 provides training time with varying band for spectral and spatial-spectral reduction approaches respectively on Trento, Houston, Muufl Datasets. Table 5 provides inference time with varying band for spectral and spatial-spectral reduction approaches respectively on Trento, Houston, Muufl Datasets.

TABLE 4

| | Spectral | | | Spectral-Spatial | | |
|---|---|---|---|---|---|---|
| Bands | R-Hop | R-TopN | R-Prox | R-Hop | R-TopN | R-Prox |
| Trento | | | | | | |
| 32 | 1080 | 870 | 1020 | 660 | 588 | 660 |
| 24 | 800 | 840 | 642 | 570 | 720 | 630 |
| 16 | 600 | 732 | 690 | 480 | 510 | 600 |
| Houston | | | | | | |
| 72 | 1785 | 660 | 660 | 840 | 720 | 720 |
| 48 | 1537 | 432 | 420 | 720 | 660 | 960 |
| 24 | 1240 | 420 | 240 | 480 | 600 | 360 |
| Muufl | | | | | | |
| 32 | 5647 | 5350 | 5388 | 2661 | 2661 | 2944 |
| 24 | 4012 | 4825 | 4620 | 2227 | 2227 | 2177 |
| 16 | 3471 | 3494 | 3528 | 1983 | 1991 | 2010 |

TABLE 5

| | Spectral | | | Spectral-Spatial | | |
|---|---|---|---|---|---|---|
| Bands | R-Hop | R-TopN | R-Prox | R-Hop | R-TopN | R-Prox |
| Trento | | | | | | |
| 32 | 138 | 216 | 192 | 126 | 135 | 126 |
| 24 | 120 | 177.6 | 158.4 | 120 | 132 | 125 |
| 16 | 108 | 159 | 155 | 102 | 113 | 90 |
| Houston | | | | | | |
| 72 | 192 | 79 | 78 | 93 | 105 | 180 |
| 48 | 174 | 72 | 66 | 90 | 90 | 168 |
| 24 | 168 | 67 | 58 | 84 | 84 | 116 |
| Muufl | | | | | | |
| 32 | 541 | 435 | 483 | 226 | 226 | 260 |
| 24 | 403 | 435 | 434 | 196 | 192 | 192 |
| 16 | 334 | 337 | 336 | 181 | 178 | 184 |

It is observed from Table 4 and Table 5 that, with the decrease in the number of bands, both training time and inference time show a steady decrease in most cases. This behavior is expected as the number of computations decreases with the decrease in the number of spectral bands. Table 6 provides accuracy with varying band for spectral and spatial-spectral reduction approaches respectively on Trento, Houston, Muufl Datasets. For the spatial-spectral reduction approach also, both training and inference latency decrease with reduction in bands. This is achieved without adversely impacting the accuracy, as shown in Table 6. These conclusions hold for all three datasets.

TABLE 6

| | Spectral | | | Spectral-Spatial | | |
|---|---|---|---|---|---|---|
| Bands | R-Hop | R-TopN | R-Prox | R-Hop | R-TopN | R-Prox |
| Trento | | | | | | |
| 32 | 98.8 | 99.3 | 98.9 | 99.5 | 99.4 | 98.2 |
| 24 | 98.7 | 99.2 | 98.5 | 99.2 | 98.8 | 97.1 |
| 16 | 98.1 | 98.5 | 98.8 | 99.1 | 97.8 | 97.5 |
| Houston | | | | | | |
| 72 | 96.3 | 95.9 | 96.2 | 93.4 | 93.4 | 91.7 |
| 48 | 93.4 | 93.6 | 94.1 | 92.7 | 93.4 | 93.4 |
| 24 | 92.9 | 89.2 | 83.9 | 90.4 | 86.5 | 86.4 |
| Muufl | | | | | | |
| 32 | 93.6 | 92.1 | 93.5 | 91.8 | 91.8 | 91.05 |
| 24 | 93.5 | 91.6 | 92.9 | 93.5 | 93.5 | 92.34 |
| 16 | 91.8 | 86.6 | 92.2 | 91.2 | 91.1 | 92.05 |

In an embodiment, in the present disclosure, it was observed that the plurality of reflexivity-based approximate computing (RA×C) techniques consistently achieve a significantly lower training and inference latency than the baseline, PCA, and MNF methods. Further, the plurality of reflexivity-based approximate computing (RA×C) techniques attained accuracy values close to baseline execution. Table 7 highlights performance gain attained in training and inference time across the three datasets for the plurality of reflexivity-based approximate computing (RA×C) techniques. It is observed from Table 7 that the plurality of reflexivity-based approximate computing (RA×C) techniques always provide a speed-up as compared to the baseline approach.

TABLE 7

| | |
|---|---|
| Train | Inference |

Trento

| | | |
|---|---|---|
| R-HopK | 6.5x | 2.6x |
| R-TopN | 8x | 1.4x |
| R-ProxN | 6.9x | 1.4x |

Houston

| | | |
|---|---|---|
| R-HopK | 4.3x | 1.8x |
| R-TopN | 7.7x | 4.5x |
| R-ProxN | 7.7x | 4.6x |

Muufl

| | | |
|---|---|---|
| R-HopK | 1.4x | 1.5x |
| R-TopN | 1.5x | 1.9x |
| R-ProxN | 1.5x | 1.7x |

Further, for system performance of the model, spatial reduction gives a higher decrease in time for training and inference compared to spectral. This is attributed to the fact that spatial reduction techniques reduce the pixel size by 66-88%, whereas spectral reduction techniques reduce the image size by only 50%.

Spectral reduction has the most significant impact on the memory occupied by the model. Reducing the spectral bands by half reduces the model size by more than 50%. However, the spatial techniques bring a negligible reduction in model size. Hence, in case of limited resources, spectral reduction is more beneficial than spatial. The reason for this is that the model size is affected by the input size processed by the model. The hyperspectral images are divided into 11×11 patches that are fed as input to the model. Each pixel in each patch contains all the spectral bands, whereas spatially, the patch is constrained to only 121 pixels. Hence, spectral reduction has a higher impact on the model size than spatial reduction due to the reduced spatial dimension of the 11×11 input patch fed to the model. By contrast, during the training process, the entire image is iterated upon for each epoch in multiple batches of 11×11 patches, thus giving spatial and spectral dimensions equal representation.

It is observed that both PCA and MNF show significantly higher pre-processing times than the plurality of reflexivity-based approximate computing (RA×C) techniques. PCA and MNF require multiple computing steps involving eigenvalue decomposition and matrix multiplications, which add to the pre-processing time. Comparatively, the plurality of reflexivity-based approximate computing (RA×C) techniques require much lesser computation as they are based on clustering and the selection of bands based on reflectance values. The pre-processing time of PCA and MNF ranges from 2 times to 6 times compared to the plurality of reflexivity-based approximate computing (RA×C) techniques. Combining spatial and spectral reduction does lead to a reduction in the model size as compared to only spectral reduction. However both approaches perform reasonably well in terms of training/inference latency and accuracy. This approach is beneficial in a resource (memory) constrained environment. PCA and MNF are generic statistical techniques that can provide valuable insights into the variance and noise in the data. However, they do not inherently consider class relationships. The plurality of reflexivity-based approximate computing (RA×C) techniques highlight subtle spectral variations in data, which are beneficial when distinguishing among classes, leading to higher classification accuracy. In the present disclosure, extensive ablation studies are conducted. On reducing the number of spectral bands, both spectral only and combination of the spectral and spatial reduction techniques bring proportionate reduction in training and inference latency. This confirms the efficacy of the method of the present disclosure.

The written description describes the subject matter herein to enable any person skilled in the art to make and use the embodiments. The scope of the subject matter embodiments is defined herein and may include other modifications that occur to those skilled in the art. Such other modifications are intended to be within the scope of the present disclosure if they have similar elements that do not differ from the literal language of the embodiments or if they include equivalent elements with insubstantial differences from the literal language of the embodiments described herein.

The present disclosure addresses the challenges associated with large sizes of hyperspectral data in order to optimize the training and inference latency of models in the remote sensing domain. The plurality of reflexivity-based approximate computing (RA×C) techniques are used for dimensionality reduction using reflectance spectra. Three spectral clustering methods based on the reflectance values are provided, which capture inherent characteristics of hyperspectral images across different domains. The method of the present disclosure leverage physical properties of the reflectance spectra to reduce dimensionality (and consequently the training and inference time) while preserving valuable information. The efficacy of the method of the present disclosure is validated by conducting experiments on three real-world, open-source datasets that are representative of diverse rural and urban landscapes. Results have demonstrated significant speed-ups in both, training and inference time without compromising the model accuracy. Additionally, a significant model compression is achieved in all scenarios. Different modalities of data, which means data collected by different sensors, provide rich information about the environment, leading to improved data analysis and decision-making. However, with increasing number of modalities, the system performance of a model declines. Approximate computing techniques have to be explored for processing such multi-modal data.

It is to be understood that the scope of the protection is extended to such a program and in addition to a computer-readable means having a message therein; such computer-readable storage means contain program-code means for implementation of one or more steps of the method, when the program runs on a server or mobile device or any suitable programmable device. The hardware device can be any kind of device which can be programmed including e.g., any kind of computer like a server or a personal computer, or the like, or any combination thereof. The device may also include means which could be e.g., hardware means like e.g., an application-specific integrated circuit (ASIC), a field-programmable gate array (FPGA), or a combination of hardware and software means, e.g., an ASIC and an FPGA, or at least one microprocessor and at least one memory with software processing components located therein. Thus, the means can include both hardware means and software means. The method embodiments described herein could be implemented in hardware and software. The device may also include software means. Alternatively, the embodiments may be implemented on different hardware devices, e.g., using a plurality of CPUs.

The embodiments herein can comprise hardware and software elements. The embodiments that are implemented in software include but are not limited to, firmware, resident software, microcode, etc. The functions performed by various components described herein may be implemented in other components or combinations of other components. For the purposes of this description, a computer-usable or computer readable medium can be any apparatus that can comprise, store, communicate, propagate, or transport the program for use by or in connection with the instruction execution system, apparatus, or device.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items. It must also be noted that as used herein, the singular forms “a,” “an,” and “the” include plural references unless the context clearly dictates otherwise.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope of disclosed embodiments being indicated herein by the following claims.

What is claimed is:

1. A processor implemented method, comprising:
receiving, via one or more hardware processors, a plurality of hyperspectral image patches of one or more regions of earth's surface using one or more remote sensing mediums;
computing, via the one or more hardware processors, an average of a plurality of reflectance values of each of a plurality of spectral bands in each of the plurality of hyperspectral image patches;
obtaining, via the one or more hardware processors, a plurality of clusters of spectral bands based on a computed average of the plurality of reflectance values across all pixels in each of the plurality of hyperspectral image patches using a clustering technique, wherein each cluster comprises a subset of spectral bands from the plurality of spectral bands; and
performing, via the one or more hardware processors, at least one of a plurality of reflexivity-based approximate computing techniques on the plurality of hyperspectral image patches for reducing a number of the plurality of spectral bands in each of the plurality of hyperspectral image patches by, wherein the plurality of reflexivity-based approximate computing techniques comprise (i) a R-Hop(K) technique, a R-Top(N) technique and a R-Proximity(N) technique.

2. The processor implemented method of claim 1, wherein the R-Hop(K) technique comprises:
ranking each spectral band in the plurality of spectral bands in an order of the plurality of reflectance values; and
performing a uniform sampling on the ranked plurality of spectral bands by selecting a plurality of alternate bands from the ranked plurality of spectral bands based on a prespecified hop size K, wherein the plurality of alternate bands represent a reduced number of the plurality of spectral bands.

3. The processor implemented method of claim 1, wherein the R-Top(N) technique comprising:
ranking each spectral band in the subset of spectral bands comprised in each cluster in an order of the plurality of reflectance values; and
performing a uniform sampling on the ranked subset of spectral bands in each cluster by selecting a plurality of N high ranked bands from the ranked subset of spectral bands, wherein the plurality of N high ranked bands represent a reduced number of the subset of spectral bands.

4. The processor implemented method of claim 1, wherein the R-Proximity(N) technique comprising:
ranking each spectral band in the subset of spectral bands comprised in each cluster in an order of the plurality of reflectance values; and
performing a uniform sampling on the ranked subset of spectral bands in each cluster by selecting a plurality of N closest bands from the ranked subset of spectral bands based on a distance from a centroid of each cluster, wherein the plurality of N closest bands represent a reduced number of the subset of spectral bands.

5. A system, comprising:
a memory storing instructions;
one or more communication interfaces; and
one or more hardware processors coupled to the memory via the one or more communication interfaces, wherein the one or more hardware processors are configured by the instructions to:
receive a plurality of hyperspectral image patches of one or more regions of earth's surface using one or more remote sensing mediums;
compute an average of a plurality of reflectance values of each of a plurality of spectral bands in each of the plurality of hyperspectral image patches;
obtain a plurality of clusters of spectral bands based on a computed average of the plurality of reflectance values across all pixels in each of the plurality of hyperspectral image patches using a clustering technique, wherein each cluster comprises a subset of spectral bands from the plurality of spectral bands; and
perform at least one of a plurality of reflexivity-based approximate computing techniques on the plurality of hyperspectral image patches for reducing a number of the plurality of spectral bands in each of the plurality of hyperspectral image patches, wherein the plurality of reflexivity-based approximate computing techniques comprise (i) a R-Hop(K) technique, a R-Top(N) technique and a R-Proximity(N) technique.

6. The system of claim 5, wherein the R-Hop(K) technique comprising:
ranking each spectral band in the plurality of spectral bands in an order of the plurality of reflectance values; and
performing a uniform sampling on the ranked plurality of spectral bands by selecting a plurality of alternate bands from the ranked plurality of spectral bands based on a prespecified hop size K, wherein the plurality of alternate bands represent a reduced number of the plurality of spectral bands.

7. The system of claim 5, wherein the R-Top(N) technique comprising:
ranking each spectral band in the subset of spectral bands comprised in each cluster in an order of the plurality of reflectance values; and
performing a uniform sampling on the ranked subset of spectral bands in each cluster by selecting a plurality of N high ranked bands from the ranked subset of spectral bands, wherein the plurality of N high ranked bands represent a reduced number of the subset of spectral bands.

8. The system of claim 5, wherein the R-Proximity(N) technique comprising:
ranking each spectral band in the subset of spectral bands comprised in each cluster in an order of the plurality of reflectance values; and
performing a uniform sampling on the ranked subset of spectral bands in each cluster by selecting a plurality of N closest bands from the ranked subset of spectral bands based on a distance from a centroid of each cluster, wherein the plurality of N closest bands represent a reduced number of the subset of spectral bands.

9. One or more non-transitory machine-readable information storage mediums comprising one or more instructions which when executed by one or more hardware processors cause:
receiving a plurality of hyperspectral image patches of one or more regions of earth's surface using one or more remote sensing mediums;
computing an average of a plurality of reflectance values of each of a plurality of spectral bands in each of the plurality of hyperspectral image patches;
obtaining a plurality of clusters of spectral bands based on a computed average of the plurality of reflectance values across all pixels in each of the plurality of hyperspectral image patches using a clustering technique, wherein each cluster comprises a subset of spectral bands from the plurality of spectral bands; and
performing at least one of a plurality of reflexivity-based approximate computing techniques on the plurality of hyperspectral image patches for reducing a number of the plurality of spectral bands in each of the plurality of hyperspectral image patches by, wherein the plurality of reflexivity-based approximate computing techniques comprise (i) a R-Hop(K) technique, a R-Top(N) technique and a R-Proximity(N) technique.

10. The one or more non-transitory machine-readable information storage mediums of claim 9, wherein the R-Hop(K) technique comprises:
ranking each spectral band in the plurality of spectral bands in an order of the plurality of reflectance values; and
performing a uniform sampling on the ranked plurality of spectral bands by selecting a plurality of alternate bands from the ranked plurality of spectral bands based on a prespecified hop size K, wherein the plurality of alternate bands represent a reduced number of the plurality of spectral bands.

11. The one or more non-transitory machine-readable information storage mediums of claim 9, wherein the R-Top(N) technique comprising:
ranking each spectral band in the subset of spectral bands comprised in each cluster in an order of the plurality of reflectance values; and
performing a uniform sampling on the ranked subset of spectral bands in each cluster by selecting a plurality of N high ranked bands from the ranked subset of spectral bands, wherein the plurality of N high ranked bands represent a reduced number of the subset of spectral bands.

12. The one or more non-transitory machine-readable information storage mediums of claim 9, wherein the R-Proximity(N) technique comprising:
ranking each spectral band in the subset of spectral bands comprised in each cluster in an order of the plurality of reflectance values; and
performing a uniform sampling on the ranked subset of spectral bands in each cluster by selecting a plurality of N closest bands from the ranked subset of spectral bands based on a distance from a centroid of each cluster, wherein the plurality of N closest bands represent a reduced number of the subset of spectral bands.
